(19) United States
(12) Patent Application Publication
(10) Pub. No.: US 2020/0372450 A1
(43) Pub. Date: Nov. 26, 2020

(54) DETERMINING RFID TAG ORIENTATION FOR VIRTUAL SHIELDING

(71) Applicant: Sensormatic Electronics, LLC, Boca Raton, FL (US)

(72) Inventors: Jay LICKFETT, San Diego, CA (US); Mayuri SARUPURI, Brea, CA (US)

(21) Appl. No.: 16/881,809

(22) Filed: May 22, 2020

Related U.S. Application Data
(60) Provisional application No. 62/851,927, filed on May 23, 2019.

(51) Int. Cl. G06Q 10/08; G06K 7/10

(52) U.S. Cl. CPC G06Q 10/087; G06K 7/10366; G06K 7/10316

(57) ABSTRACT

Aspects of the present disclosure provide techniques to identify the orientation of the electronic product code (EPC) tag in order to improve the accuracy of the virtual shielding in an inventory management system. In some examples, the orientation of the EPC tag may be obtained by tracking the signal strength of the same EPC tag with an RFID reader (fixed or mobile) based on multiple reads made by the RFID reader in different known orientations and/or locations. Based on the tracking, the RFID reader may be configured to record the variable signal strengths that are detected for the EPC tag in order to determine the orientation of the EPC tag. Once the orientation of the EPC tag is identified, the RFID reader may be able to accurately determine the location of the EPC tag (e.g., on sales floor or stock room) for a more reliable virtual shielding.

### CLAIM OF PRIORITY

This application claims priority to U.S. Provisional Patent Application No. 62/851,927 entitled “Determining RFID Tag Orientation For Virtual Shielding”, which was filed on May 23, 2019 and is incorporated by reference herein.

### BACKGROUND

The present disclosure relates generally to inventory management utilizing radio-frequency identification (RFID) technology to capture electronic product code (EPC) tags, and more specifically to identifying the tag orientation for virtual shielding.

In recent years, retailers (e.g., apparel retailers) have deployed a radio frequency identification system in stores to track its products' movements as they arrive at stores, are placed on display on the sales floor, and are sold. By adopting RFID, retailers are able to reduce the amount of time that its store employees spend counting the inventory (e.g., manually counting inventor that is on the floor and in stock room), as well as increase merchandise visibility within each store, thereby enabling shoppers in the store and online to find what they seek, at the location where they need it.

Stores utilizing RFID technology for inventory management employ either overhead readers that capture all tags within a specified area or zone, or handheld readers operated by sales personnel to conduct periodic inventory counts. In either case, the isolation of reads to a particular area can be challenging because the radio signal can penetrate walls, and thus could read tags outside the intended zone. For instance, goods may be stacked against both sides of a wall separating the stock room from the store front. Thus, if a sales associate were attempting to read tags on the sales floor only, he or she might inadvertently capture reads from the products on the other side of the wall, in the stock room. Such errors can mean that replenishment of products on the sales floor would not occur when it should, and that merchandise would not be available for customers even if the RFID data indicates that the inventory on the floor needs to be replenished.

To resolve this problem, retailers have generally relied on applying either physical or virtual shielding to isolate the radio signals. Physical shielding includes installing aluminum sheets or applying special paint on the walls (e.g., walls separating the sales floor and stock room) in order to block the radio signal from penetrating through the walls. However, such infrastructure modification for retailers may be expensive and time consuming. Other potential solutions have focused on software based solution known as virtual shielding. Virtual shielding algorithms attempt to separate inventory zones without using physical radio frequency shielding. However, current virtual shielding algorithms still suffer from incorrect readings and allocation of inventory.

### SUMMARY

Aspects of the present disclosure provide techniques to identify the orientation of an electronic product code (EPC) tag in order to improve the accuracy of the virtual shielding in an inventory management system. In some examples, the orientation of the EPC tag may be obtained by tracking the signal strength of the same EPC tag with an RFID reader (fixed or mobile) based on multiple reads made by the RFID reader in different known orientations and/or locations. Based on the tracking, the RFID reader may be configured to record the variable signal strengths that are detected for the EPC tag in order to determine the orientation of the EPC tag because the signal strength of an EPC read is highly correlated to the orientation of the reader antenna relative to the EPC tag. Once the orientation of the EPC tag is identified, the RFID reader may be able to accurately determine the location of the EPC tag (e.g., on sales floor or stock room) for a more reliable virtual shielding.

In one example, a method for inventory management utilizing RFID technology is disclosed. The method may include detecting, via an antenna of a RFID reader, a first signal from an EPC tag during a first time period, wherein the RFID reader is positioned in a first RFID orientation during the first time period. The method may further include detecting, via the antenna of the RFID reader, a second signal from the EPC tag during a second time period, wherein the RFID reader is positioned in a second RFID orientation during the second time period. The method may further include measuring variance of received signal strength between the first signal and the second signal from the EPC tag. The method may further include determining an orientation of the EPC tag relative to the antenna of the RFID reader based in part on one or more of the variance of the received signal strength, the first RFID orientation, or the second RFID orientation. The method may further include identifying a location of the EPC tag based on the orientation of the EPC tag relative to the antenna of the RFID reader.

In another example, an apparatus for inventory management utilizing RFID technology is disclosed. The apparatus may include a memory configured to store instructions and a processor communicatively coupled with the memory. The processor may be configured to execute the instructions to detect, via an antenna of a RFID reader, a first signal from an EPC tag during a first time period, wherein the RFID reader is positioned in a first RFID orientation during the first time period. The processor may further be configured to execute the instructions to detect, via the antenna of the RFID reader, a second signal from the EPC tag during a second time period, wherein the RFID reader is positioned in a second RFID orientation during the second time period. The processor may further be configured to execute the instructions to measure variance of received signal strength between the first signal and the second signal from the EPC tag. The processor may further be configured to execute the instructions to determine an orientation of the EPC tag relative to the antenna of the RFID reader based in part on one or more of the variance of the received signal strength, the first RFID orientation, or the second RFID orientation. The processor may further be configured to execute the instructions to identify a location of the EPC tag based on the orientation of the EPC tag relative to the antenna of the RFID reader.

In another example, a non-transitory computer readable medium for inventory management utilizing RFID technology is disclosed. The computer readable medium may include code for detecting, via an antenna of a RFID reader, a first signal from an EPC tag during a first time period, wherein the RFID reader is positioned in a first RFID orientation during the first time period. The computer readable medium may further include code for detecting, via the antenna of the RFID reader, a second signal from the EPC tag during a second time period, wherein the RFID reader is positioned in a second RFID orientation during the second time period. The computer readable medium may further include code for measuring variance of received signal strength between the first signal and the second signal from the EPC tag. The computer readable medium may further include code for determining an orientation of the EPC tag relative to the antenna of the RFID reader based in part on one or more of the variance of the received signal strength, the first RFID orientation, or the second RFID orientation. The computer readable medium may further include code for identifying a location of the EPC tag based on the orientation of the EPC tag relative to the antenna of the RFID reader.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a retail store employing an inventory management system in accordance with aspects of the present disclosure;

FIG. 2 is an example diagram for identifying the orientation of the EPC tag in order to improve the accuracy of the virtual shielding in an inventory management system;

FIG. 3 is an example flowchart for inventory management system in accordance with aspects of the present disclosure; and

FIG. 4 is diagram illustrating an example of a hardware implementation for the computer device in accordance with various aspects of the present disclosure.

### DETAILED DESCRIPTION

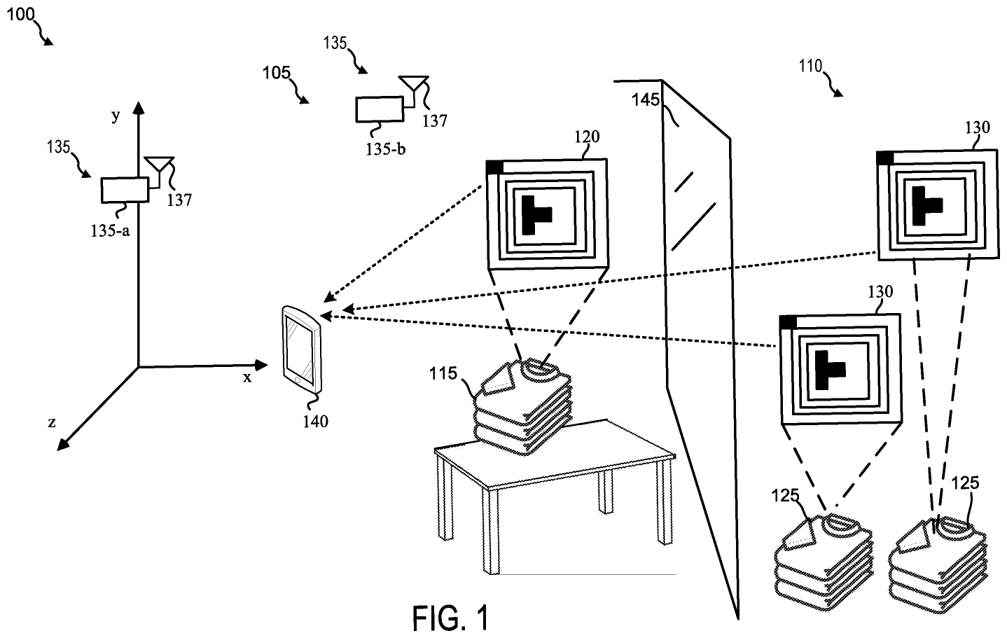

Various aspects are now described in more detail with reference to the FIGS. 1-4. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

FIG. 1 is a diagram illustrating an example of a retail store employing an inventory management system 100 in accordance with aspects of the present disclosure. In some examples, the retail space (e.g., apparel store) may be divided into a front-end “sales floor” 105 for interfacing with the customers and having on-display items 115, and a back-end stockroom 110 for storing excess inventory items 125.

As discussed above, retailers (e.g., apparel retailers) have deployed a radio frequency identification system in stores to track product movements as they arrive at stores, are placed on display on the sales floor, and are sold. By adopting RFID, retailers are able to reduce the amount of time that the store employees spend counting the inventory (e.g., manually counting inventor that is on the floor and in stock room), as well as increase merchandise visibility within each store, thereby enabling shoppers in the store and online to find what they seek, at the location where they need the product. RFID use radio waves to read and capture information stored on a tag attached to an object. A tag (e.g., EPC tag 120) can be read from up to several feet away and does not need to be within direct line-of-sight of the reader to be tracked.

Thus, an RFID system may be made up of two parts: a tag or label (e.g., EPC tag 120) and a reader (e.g., fixed RFID reader 135 or mobile RFID reader 140, which may be handheld or movable by another mechanism, such as a robot). RFID tags or labels 120 are embedded with a transmitter and a receiver. The RFID component on the tags may include a microchip that stores and processes information, and an antenna to receive and transmit a signal. The EPC tag 120 (or 130) may further contain the specific serial number for each specific object.

To read the information encoded on an EPC tag 120, a two-way radio transmitter-receiver called an interrogator or reader (e.g., RFID reader 135 or 140) emits a signal to the EPC tag 120 using the antenna (e.g., antenna 137 for fixed RFID reader 135 and internal antennas for mobile RFID reader 140). For purposes of this disclosure, the term “mobile” RFID reader may be used interchangeably with “handheld” RFID reader. It should be appreciated that a mobile/handheld RFID reader does not necessarily require a person to physically carry the RFID reader. Instead, an RFID reader that is attached to a movable device or structure (e.g., robot) is contemplated to fall within the meaning of “handheld” or “mobile” RFID reader. The EPC tag 120 may respond with the information (e.g., serial number) written in the memory bank. For purposes of this disclosure, the terms, the EPC tag and RFID tag may be used interchangeably. The EPC tag 120 may be a passive tag or a battery powered EPC tag. A passive RFID tag may use the RFID interrogator or receiver's 140 radio wave energy to relay the stored information back to the interrogator. In contrast, a battery powered EPC tag 120 may be embedded with a small battery that powers the relay of information.

In a retail setting, EPC tags 120 and 130 may be attached to articles of clothing or any merchandise. When an inventory associate uses a mobile RFID reader to scan a shelf of jeans or shirt, the associate is able to differentiate between two pairs of identical jeans based upon the information stored on the RFID tag without the need to individually scan each article of clothing because each pair will have its own serial number and the RFID receiver 140 may be able to read a plurality of EPC tags 120 on the floor of a plurality of different merchandise in one instance.

As such, with one pass of the mobile RFID reader 140, the associate can not only find a specific pair, but the RFID reader 140 may also output inventory count of how many of each pair are on the shelf and which pairs need to be replenished. The employee can learn all of this information without having to scan each individually.

Thus, retail stores utilizing RFID technology for inventory management generally employ either overhead readers 135 that capture all tags within a specified area or zone, or mobile readers 140 operated by employee to conduct periodic inventory counts. In either case, the isolation of reads to a particular area can be challenging because the radio signal can penetrate wall(s) 145, and thus could read tags outside the intended zone. For instance, goods may be stacked against both sides of a wall 145 separating the stock room 110 from the store front 105 (e.g., stocked inventory 125 and on-display items 115). Thus, if a sales associate were attempting to read tags on the sales floor only 105, the RFID reader (135 or 140) may inadvertently capture reads from the products 125 on the other side of the wall 145 in the stock room 110. Such errors can mean that replenishment of products on the sales floor 105 would not occur when it should, and that merchandise would not be available for customers even if the RFID data indicates that the inventory on the floor needs to be replenished.

To resolve this problem, retailers have generally relied on applying either physical or virtual shielding to isolate the radio signals. Physical shielding includes installing aluminum sheets or applying special paint on the walls in order to block the radio signal from penetrating through the walls. However, such infrastructure modification for retailers may be expensive and time consuming. Other potential solutions have focused on software based solution known as virtual shielding. Virtual shielding algorithms attempt to separate inventory zones without using physical radio frequency shielding.

Virtual shielding algorithms can utilize multiple data inputs to cluster EPC tag reads in order to place tags in separate inventory zones (e.g., sales floor 105 and backroom stockroom 110) without using physical RF shielding. Some inputs considered by virtual shielding solutions may include past recorded positions of items and beacon tags, correlation by time of the reads, and the signal strength of the radio frequency (RF) signal received from the EPC tag (e.g., EPC tag 120). While the signal strength of the EPC tag may be an important input variable, the signal strength itself is dependent on the orientation of the EPC tag to the reader. For example, if the EPC tag for an apparel is lying flat (e.g., horizontal), the RFID reader may have a different signal strength reading from the EPC tag than if the same EPC tag for the same apparel was vertical or at an angle to the orientation of the RFID antenna reader, even if the distance between the EPC tag and the RFID reader in both instance remained constant. As such, different signal strength readings may result in the EPC tag being erroneously allocated to a different location on the retail floor (e.g., different zones in a store).

In other examples, as illustrated in FIG. 1, the orientation of the EPC tags (e.g., first EPC tag 120 and second EPC tag 130) may impact the detected signal strength of the RF signal at the RFID reader 140 (or in case of fixed reader, RFID reader 135) such that both signal strengths may be same (or substantially same). In such instance, the RFID reader 140 may erroneously count the stocked inventory 125 as also being on the sales floor. Thus, in the illustrated example, the RFID reader may determine that the sales floor has nine shirts on the sales floor and thus there is no need to replenish the floor inventory. This would be an incorrect reading. Thus, current virtual shielding algorithms that rely on signal strength of the EPC tag, without consideration of the EPC tag, are prone to output inconsistent and inaccurate results.

Aspects of the present disclosure provide techniques to identify the orientation of the EPC tag (120 or 130) in order to improve the accuracy of the virtual shielding in an inventory management system. In some examples, the orientation of the EPC tag may be obtained by tracking the signal strength of the same EPC tag (e.g., first EPC tag 120) with an RFID reader (fixed 135 or mobile 140, separately and collectively referred to as “RFID reader” 140) based on multiple reads made by the RFID reader 135 and 140 in different known orientations and/or locations. For example, the signal strength of an EPC read signal (e.g., a signal that is emitted from the EPC tag 120 and subsequently detected by the RFID reader, such as a received signal strength indicator (RSSI), hereinafter “EPC read signal”) may be correlated to the orientation of the RFID reader antenna relative to the EPC tag 120. Based on the received signal strength of the EPC read signal, the orientation of the EPC tag 120 may be obtained by tracking multiple reads (e.g., multiple received EPC read signals) of the same tag made with the RFID reader in different known orientations and recording the variable received signal strengths in the respective orientations. In one example, the received signal strength of the EPC read signal will be stronger when the EPC tag 120 is facing the RFID reader antenna, e.g., both are aligned in the same plane (e.g., both the EPC tag 120 and the RFID reader are oriented in an x-y axis) as compared to the EPC tag 120 and the RFID reader antenna having a different relative orientation (e.g., the plane of the EPC tag 120 rotated to some degree about the x-axis and/or the y-axis relative to the plane of the RFID reader antenna). In other words, the received signal strength of the EPC read signal will be strongest when it emanates from the EPC tag 120 normal to a surface of the EPC tag 120 and in a direction that is aligned with the RFID reader antenna. Multiple readings of the EPC tag 120, with different orientations of the RFID reader antenna, may allow to accurately determine the orientation of the EPC tag 120. Based on the orientation of the EPC tag 120, a location of the EPC tag 120 and the item to which the EPC tag 120 is attached can be determined.

For example, for a mobile RFID reader 140, the RFID reader 140 may obtain multiple reads of an EPC tag from different locations in the store at different time periods in order to determine the orientation of the EPC tag 120 in relation to the mobile RFID reader 140. With respect to the fixed RFID reader 135, multiple readings may be obtained by multiple fixed RFID readers (e.g., first fixed RFID reader 135-a and second fixed RFID reader 135-b) in order to identify the orientation of the EPC tag 120 relative to the antennas 137 of the each RFID reader 135.

Based on the tracking, the RFID reader may be configured to record the variable signal strengths that are detected for the EPC tag 120 in order to determine the orientation of the EPC tag 120 because the signal strength of an EPC tag 120 read is highly correlated to the orientation of the reader antenna relative to the EPC tag 120. Once the orientation of the EPC tag 120 is identified relative to the RFID reader antenna, the RFID reader 140 may be able to accurately determine the location of the EPC tag 120 (e.g., on sales floor 105 or stock room 110) for a more reliable virtual shielding. Using this technique, virtual shielding can be improved, as the signal strength of EPC read signals from different EPC tags may be properly interpreted in the context of the physical orientation of the individual EPC tags.

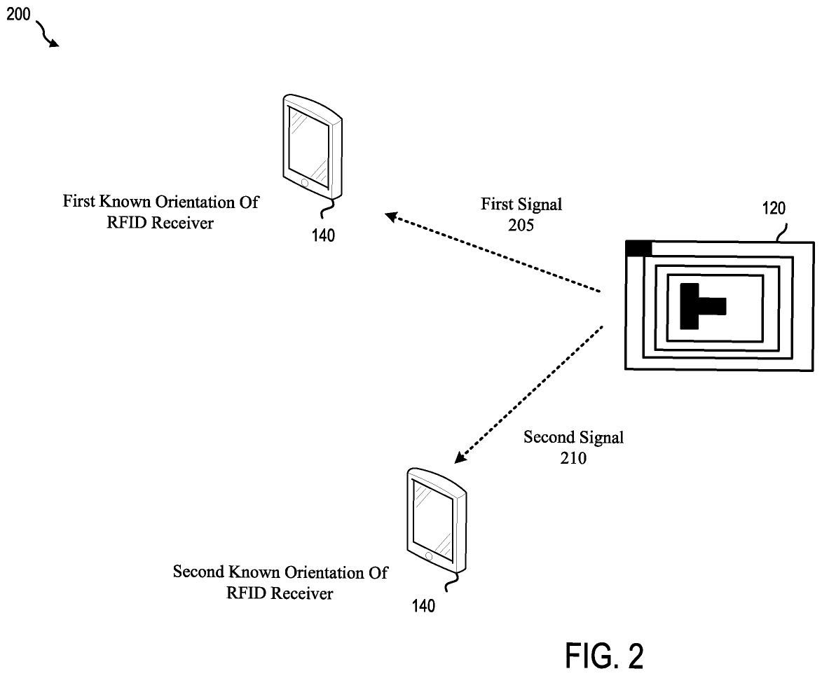

Turning next to FIG. 2, an example diagram 200 is disclosed for identifying the orientation of the EPC tag 120 in order to improve the accuracy of the virtual shielding in an inventory management system. In some examples, the process of identifying the orientation of the EPC tag 120 may include storing, during an initial time period, the first orientation of the RFID reader 140 at the time that the inventory scan is initiated. The orientation of RFID reader 140 may be determined based in part on one or more sensors associated with the RFID reader 140, including but not limited to accelerometer, compass, and other built-in sensors on the mobile device that may be paired with the mobile RFID antenna. In the case of a fixed RFID reader 135 (not shown in FIG. 2), the orientation of each fixed RFID reader 135 may be stored in the memory of the RFID receiver 135 when the receiver is fixed or attached to a particular location (e.g., on the ceiling or wall) in the retail space.

At the first time period, the RFID reader 140 may detect a first signal 205 that may be received from the EPC 120 in response to the two-way radio transmitter-receiver (e.g., RFID reader 130 or 140) emitting a scan signal to the EPC tag 120 using one or more antennas (e.g., antenna 137 for fixed RFID reader 135 and internal antennas for mobile RFID reader 140) communicatively coupled with the RFID reader 140. The first signal 205 may include information (e.g., serial number) written in the memory bank of the EPC tag 120 associated with, for example, an article of clothing.

Upon receiving the first signal, the RFID reader 140 may measure the first received signal strength (e.g., received signal strength indicator (RSSI)) associated with the first signal. The RFID reader 140 may further correlate the first received signal strength information with the first orientation of the RFID receiver 140 during the first time period.

During the second time period, the RFID reader 140 may perform a second scan of the same EPC tag 120 by transmitting a scan signal to the EPC tag 120 using one or more antennas. In some examples, the location of the RFID reader 140 during the first time period may be different from the location of the RFID reader 140 during the second time period (e.g., the RFID receiver may initiate the scan from different part of the retail space). Additionally or alternatively, prior to (or during) the second scan, the RFID reader 140 may store a second orientation of the RFID reader 140 based in part on one or more sensors associated with the RFID receiver 140. At the second time period, the RFID reader 140 may receive a second signal 210 from the EPC tag 120 and measure the corresponding second received signal strength of the second signal 210. The RFID reader 140 may further correlate the second received signal strength of the second signal 210 with the second orientation of the RFID reader 140.

As such, the RFID reader 140 (or a back-end computer communicatively coupled with the RFID receiver 140) may determine the orientation of the EPC tag 120 relative to one or more antennas of the RFID reader 140 based in part on a combination of the first and second orientation of the RFID reader, and the received signal strength of the first and second signals. In accordance with aspects of the present disclosure, the combination of multiple radio signal from multiple angles of the same EPC tag allow the RFID reader to subsequently determine the orientation of EPC tag 120 in relation to the one or more antennas of the RFID readers. Because the signal strength of the EPC read is highly correlated to the orientation of the RFID reader 140, features of the present disclosure leverage this property to determine the orientation of the EPC tag by tracking multiple reads of the same EPC tag 120 with the RFID reader 140 in different known orientations and recording the variable signal strengths that may be returned. Once the orientation of the EPC tag 120 is determined, the location of the EPC tag 120 may be identified for purposes of the virtual shielding with greater accuracy than current algorithms afford in the context of the physical orientation of the individual EPC tags 120 in the three dimensional (3D) space of the retail store.

The position of the RFID reader 140 in a three-dimensional space may be further refined using one or more hardware modules such as an accelerometer, a compass, an inertial measurement unit, and other built-in sensors, and/or one or more software modules such as triangulation algorithms on the mobile device paired to the RFID reader 140. The refinements may be implemented using onboard sensors or capabilities, or by sensor fusion with other external data streams. With the above mentioned techniques, a determination of the RFID tag orientation, and therefore the ability to perform a more accurate placement of the RFID tag in a three-dimensional space can be achieved.

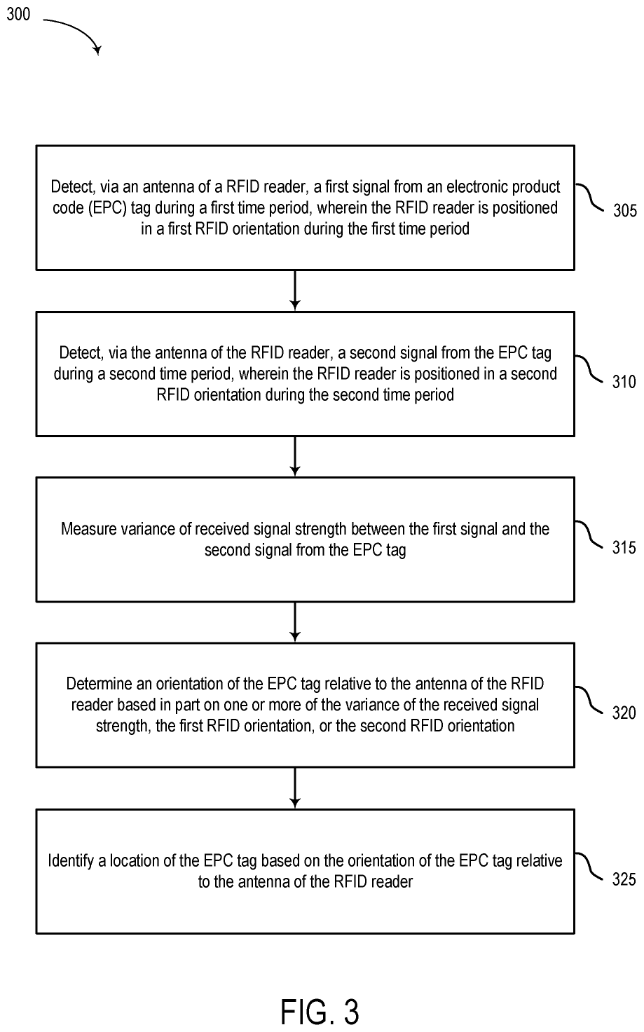

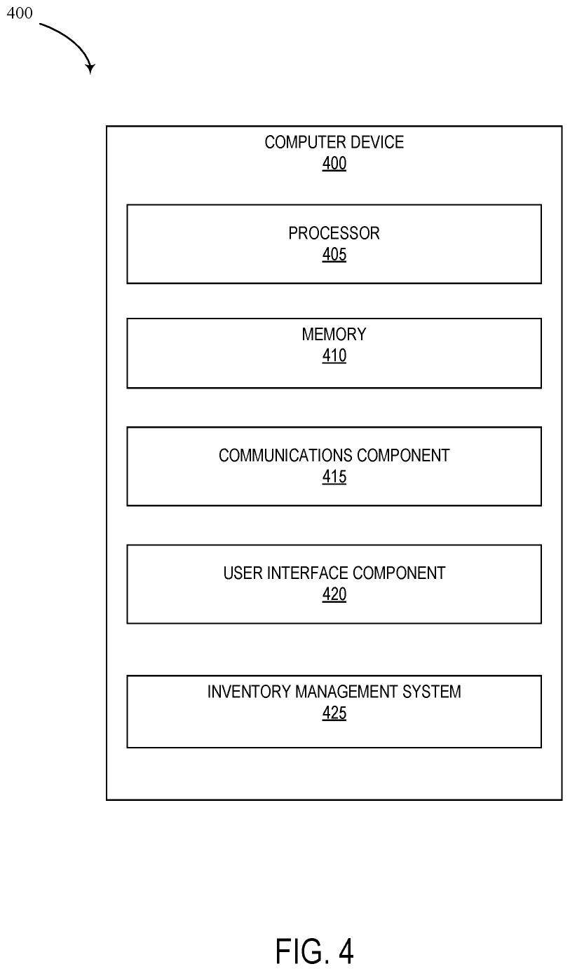

FIG. 3 is flowchart 300 for inventory management utilizing radio-frequency identification (RFID) technology in accordance with aspects of the present disclosure. Aspects of flowchart 300 may be performed by the RFID reader (135 or 140) as described with reference to FIG. 1 and/or by a computer device 400 in communication with the RFID reader as described with reference to FIG. 4.

At block 305, the method 300 may include detecting, via an antenna of a RFID reader, a first signal from an electronic product code (EPC) tag during a first time period, wherein the RFID reader is positioned in a first RFID orientation during the first time period. For example, the first position and orientation of the RFID reader may be based on estimates using data from one or more sensors on the RFID reader as well as location information of the RFID reader. In one implementation, when the RFID reader is the fixed RFID reader 135 (as described above with reference to FIGS. 1 and 2), the RFID reader position and orientation may be known based on a location of the RFID reader 135 and the orientation of the RFID reader antenna 137 stored in a memory 410 of the computer device 400. In another implementation, when the RFID reader is the mobile RFID reader 140, the position of the mobile RFID reader 140 may be determined based on one or more sensors, a compass, an inertial measurement unit, or a global positioning system (GPS) receiver, and the orientation of the mobile RFID reader 140 may be determined based on one or more sensors, accelerometers, compass, etc. Aspects of block 305 may be performed by communications component 415 and more particularly by one or more antennas (e.g., antenna 137) associated with the one or more RFID readers.

At block 310, the method 300 may include detecting, via the antenna of the RFID reader, a second signal from the EPC tag during a second time period, wherein the RFID reader is positioned in a second RFID orientation during the second time period. In some examples, the first RFID orientation during the first time period and the second RFID orientation during the second time period may be known or derived values/information that are determined based in part on one or more sensors associated with the RFID reader as described above in operations at block 305. The one or more sensors may include 3D accelerometer, 3D gyroscope, or a compass. However, it should be appreciated any other inertial sensors may also be used to identify position and orientation in 3D space. Aspects of block 310 may also be performed by communications component 415 and more particularly by one or more antennas (e.g., antenna 137) associated with the one or more RFID readers 135 and 140.

At block 315, the method 300 may include measuring variance of received signal strength between the first signal and the second signal from the EPC tag. For example, the communications component 415 may determine a received signal strength of the first signal detected at block 305 and a received signal strength of the second signal detected at block 310. The communications component 415 may then determine the variance of the received signal strength of the first signal and the received signal strength of the second signal. In one implementation, the communications component 415 may iteratively determine the received signal strengths of the first and second signals, and use multiple readings of the first and second signals to determine variance of the received signal strengths of the first and second signals. For example, the communications component 415 may determine multiple variance values for each of the multiple readings of the first and second signals. The communications component 415 may then determine an average of the multiple variance values to determine the variance. Aspects of block 315 may be performed by the inventory management system 425 described with reference to FIG. 4.

At block 320, the method 300 may include determining an orientation of the EPC tag relative to the antenna of the RFID reader based in part on one or more of the variance of the received signal strength, the first RFID orientation, or the second RFID orientation. In one implementation, an inventory management system 425 in the computer device 400 may determine the orientation of the EPC tag 120 based on one or more of the variance of the received signal strength, the first RFID orientation, or the second RFID orientation. For example, based on the variance of the received signal strength between the first and the second RFID orientations, the inventory management system 425 may determine an orientation of the EPC tag 120 (e.g., an angle of inclination of the EPC tag 120 with each of the x, y and z-axis) based on a machine learning based model that develops weightings between different inputs. The model may be based on one or more readings of the EPC tag 120 from the one or more RFID readers (such as the fixed RFID reader 135 and the mobile RFID reader 140). In one example, the inputs to the model may include RFID reader location(s) (e.g., the location of the fixed RFID reader 135, which may be precisely known, and the location of the mobile RFID reader 140, with the location of the mobile RFID reader 140 determined based on one or more of user input, GPS, wireless fidelity (Wi-Fi), RFID beacons and/or an external derived localization scheme such as proximity to one or more other tags of known locations). Further, the inputs to the model may include the RFID reader orientation(s) (e.g., the orientation of the fixed RFID reader 135, which may be precisely known, and the orientation of the mobile RFID reader 140, which may be derived using parameters including pitch (angle of the mobile RFID reader 140 with the x-axis), yaw (angle of the mobile RFID reader 140 with the y-axis), and roll (angle of the mobile RFID reader 140 with the z-axis), with the pitch, yaw and roll parameters based on readings from one or more sensors, compass, and/or accelerometer on the mobile RFID reader 140). Also, the inputs to the model may include RFID antenna polarization, antenna gain, transmission power, RFID receiver sensitivity, RSSI, time of reading the EPC tag 120. Further, the model may include inputs that may be used in conjunction with RFID tag readings such as item related information to which a tag is attached, e.g., based on the serial number of the EPC tag 120, the item to which the EPC tag 120 is attached may be identified, and using the item information (e.g., item type, item material, etc.) orientation of the EPC tag 120 may be predicted. For instance, if the item is a formal suit, the EPC tag 120 is likely to be in a hanging/vertical orientation aligned or extending along the y-axis). Other inputs to the model may include attachment technique of the EPC tag 120 (e.g., whether the EPC tag 120 is an embedded, a hang tag, a sewn tag, etc.), size of the EPC tag 120, type of the EPC tag 120 (e.g., active/passive, unidirectional/omnidirectional, etc.), last known location of the EPC tag 120, last predicted orientation of the EPC tag 120, expected location of the EPC tag 120 (e.g., stocked inventory, displayed inventory, etc.). The model may determine the orientation of the EPC tag 120 by processing and weighing one or any combination of the above inputs, in order to determine the orientation of the EPC tag 120. Aspects of block 320 may also be performed by the inventory management system 425 described with reference to FIG. 4.

At block 325, the method 300 may include identifying a location of the EPC tag based on the orientation of the EPC tag relative to the antenna of the RFID reader. For example, the inventory management system 425 may identify the location of the EPC tag 120 based on the orientation of the EPC tag 120, the item to which the EPC tag 120 is attached, expected location of the item to which the EPC tag 120 is attached, etc. In some examples, the method may further include outputting an inventory count associated with the EPC tag in a zone of interest. Outputting an inventory may comprise displaying the inventory count on a display device associated with the RFID reader or a separate computer. In some examples, the zone of interest may be one of a front-end sales floor or a stockroom in a retail store. Additionally or alternatively, identifying the location of the EPC tag may be performed by generating virtual shielding to separate the zones of physical space (e.g., without requiring any physical modifications such as aluminum sheets or applying special paint on the walls to prevent radio signals from penetrating the walls). Aspects of block 325 may also be performed by the inventory management system 425 described with reference to FIG. 4.

Referring now to FIG. 4, a diagram illustrating an example of a hardware implementation for the computer device 400 in accordance with various aspects of the present disclosure is described. In some examples, the computer device 400 may be an example of the fixed RFID reader, mobile RFID reader, or a backend computer device such as a standalone computer or a server in communication with one or more RFID readers that capture signals from one or more EPC tags with reference to FIG. 1.

The computer device 400 may include a processor 405 for carrying out one or more processing functions (e.g., method 300) described herein. The processor 405 may include a single or multiple set of processors or multi-core processors. Moreover, the processor 405 can be implemented as an integrated processing system and/or a distributed processing system.

The computer device 400 may further include a memory 410, such as for storing local versions of applications being executed by the processor 405. In some aspects, the memory 410 may be implemented as a single memory or partitioned memory. In some examples, the operations of the memory 310 may be managed by the processor 405. Memory 410 can include a type of memory usable by a computer, such as random access memory (RAM), read only memory (ROM), tapes, magnetic discs, optical discs, volatile memory, non-volatile memory, and any combination thereof. Additionally, the processor 405, and memory 410, may include and execute operating system (not shown).

Further, the computer device 400 may include a communications component 515 that provides for establishing and maintaining communications with one or more parties utilizing hardware, software, and services as described herein. Communications component 415 may carry communications between components and modules of the computer device 400. The communications component 415 may also facilitate communications with external devices to the computer device 400, such as to electronic devices coupled locally to the computer device 400 and/or located across a communications network and/or devices serially or locally connected to the computer device 400. For example, communications component 415 may include one or more buses operable for interfacing with external devices.

The computer device 400 may include a user interface component 420 operable to receive inputs from a user of the computer device 400 and further operable to generate outputs for presentation to the user. The user interface component 400 may include one or more input devices, including but not limited to a navigation key, a function key, a microphone, a voice recognition component, any other mechanism capable of receiving an input from a user, or any combination thereof. For example, the user interface component 400 may include a trigger to initiate a RFID scan for inventory management. Further, user interface component 420 may include one or more output devices, including but not limited to a display, a speaker, any other mechanism capable of presenting an output to a user, or any combination thereof.

The computer device 400 may further include an inventory management system 425 to perform one or more techniques discussed in this application, including identifying the orientation of the EPC tag and determining the location of the EPC tag in physical space for purposes of virtual shielding and inventory counting.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a device, which can be a wired device or a wireless device. A wireless device may be a mobile RFID reader, a mobile device, cellular telephone, a satellite phone, a cordless telephone, a Session Initiation Protocol (SIP) phone, a wireless local loop (WLL) station, a personal digital assistant (PDA), a mobile device having wireless connection capability, a computer device, or other processing devices connected to a wireless modem.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It should be appreciated to those of ordinary skill that various aspects or features are presented in terms of systems that may include a number of devices, components, modules, and the like. It is to be understood and appreciated that the various systems may include additional devices, components, modules, etc. and/or may not include all of the devices, components, modules etc. discussed in connection with the figures.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for inventory management utilizing radio-frequency identification (RFID) technology, comprising:
detecting, via an antenna of a RFID reader, a first signal from an electronic product code (EPC) tag during a first time period, wherein the RFID reader is positioned in a first RFID orientation during the first time period;
detecting, via the antenna of the RFID reader, a second signal from the EPC tag during a second time period, wherein the RFID reader is positioned in a second RFID orientation during the second time period;
measuring variance of received signal strength between the first signal and the second signal from the EPC tag;
determining an orientation of the EPC tag relative to the antenna of the RFID reader based in part on one or more of the variance of the received signal strength, the first RFID orientation, or the second RFID orientation; and
identifying a location of the EPC tag based in part on the orientation of the EPC tag relative to the antenna of the RFID reader.

2. The method of claim 1, further comprising:
outputting an inventory count associated with the EPC tag in a zone of interest.

3. The method of claim 2, wherein the zone of interest is one of a front-end sales floor or a stockroom in a retail store.

4. The method of claim 1, wherein identifying the location of the EPC tag based in part on the orientation of the EPC tag relative to the antenna of the RFID reader is performed by generating virtual shielding to separate zones of physical space.

5. The method of claim 1, wherein the first RFID orientation during the first time period and the second RFID orientation during the second time period are determined based in part on one or more sensors associated with the RFID reader.

6. The method of claim 5, wherein the one or more sensors associated with the RFID reader are one or more of a three dimensional (3D) accelerometer, 3D gyroscope, or a compass.

7. The method of claim 1, wherein measuring the variance of received signal strength between the first signal and the second signal from the EPC tag further comprises:
determining a received signal strength of the first signal;
determining a received signal strength of the second signal; and
determining the variance of the received signal strength between the received signal strength of the first signal and the received signal strength of the second signal.

8. The method of claim 7, further comprising:
determining a plurality of variance values from a plurality of received signal strength readings of the first signal and a plurality of received signal strength readings of the second signal; and
determining an average of the plurality of variance values as the variance of the received signal strength between the first signal and the second signal.

9. The method of claim 1, wherein determining the orientation of the EPC tag relative to the antenna of the RFID reader comprises using a machine learning based model that develops weightings between different inputs, the inputs to the machine learning based model comprising one or more of:
location of the RFID reader;
orientation of the RFID reader;
antenna polarization of the antenna of the RFID reader;
antenna gain of the antenna of the RFID reader;
transmission power of the RFID reader;
sensitivity of a receiver of the RFID reader;
received signal strength indicator (RSSI);
time of reading the EPC tag;
item information of an item to which the EPC tag is attached;
an attachment technique of the EPC tag;
size of the EPC tag;
type of the EPC tag;
last known location of the EPC tag; or
last predicted orientation of the EPC tag.

10. An apparatus for inventory management utilizing radio-frequency identification (RFID) technology, comprising:
a memory configured to store instructions;
a processor communicatively coupled with the memory, the processor configured to execute the instructions to:
detect, at an antenna of a RFID reader, a first signal from an electronic product code (EPC) tag during a first time period, wherein the RFID reader is positioned in a first RFID orientation during the first time period;
detect, at the antenna of the RFID reader, a second signal from the EPC tag during a second time period, wherein the RFID reader is positioned in a second RFID orientation during the second time period;
measure variance of received signal strength between the first signal and the second signal from the EPC tag;
determine an orientation of the EPC tag relative to the antenna of the RFID reader based in part on one or more of the variance of the received signal strength, the first RFID orientation, or the second RFID orientation; and
identify a location of the EPC tag based on the orientation of the EPC tag relative to the antenna of the RFID reader.

11. The apparatus of claim 10, wherein the processor is further configured to execute the instructions to:
output an inventory count associated with the EPC tag in a zone of interest.

12. The apparatus of claim 11, wherein the zone of interest is one of a front-end sales floor or a stockroom in a retail store.

13. The apparatus of claim 10, wherein identifying the location of the EPC tag based in part on the orientation of the EPC tag relative to the antenna of the RFID reader is performed by generating virtual shielding to separate zones of physical space.

14. The apparatus of claim 10, wherein the first RFID orientation during the first time period and the second RFID orientation during the second time period are determined based in part on one or more sensors associated with the RFID reader.

15. The apparatus of claim 14, wherein the one or more sensors associated with the RFID reader are one or more of a three dimensional (3D) accelerometer, 3D gyroscope, or a compass.

16. The apparatus of claim 10, wherein the processor configured to execute the instructions to measure variance of received signal strength between the first signal and the second signal from the EPC tag further comprises:
determine a received signal strength of the first signal;
determine a received signal strength of the second signal; and
determine the variance of the received signal strength between the received signal strength of the first signal and the received signal strength of the second signal.

17. The apparatus of claim 16, wherein the processor is further configured to execute instructions to:
determine a plurality of variance values from a plurality of received signal strength readings of the first signal and a plurality of received signal strength readings of the second signal; and
determine an average of the plurality of variance values as the variance of the received signal strength between the first signal and the second signal.

18. The apparatus of claim 10, wherein the processor configured to determine the orientation of the EPC tag relative to the antenna of the RFID reader further comprises executing the instructions to use a machine learning based model that develops weightings between different inputs, the inputs to the machine learning based model comprising one or more of:
location of the RFID reader;
orientation of the RFID reader;
antenna polarization of the antenna of the RFID reader;
antenna gain of the antenna of the RFID reader;
transmission power of the RFID reader;
sensitivity of a receiver of the RFID reader;
received signal strength indicator (RSSI);
time of reading the EPC tag;
item information of an item to which the EPC tag is attached;
an attachment technique of the EPC tag;
size of the EPC tag;
type of the EPC tag;
last known location of the EPC tag; or
last predicted orientation of the EPC tag.

19. A computer readable medium for inventory management utilizing radio-frequency identification (RFID) technology, comprising code for:
detecting, at an antenna of a RFID reader, a first signal from an electronic product code (EPC) tag during a first time period, wherein the RFID reader is positioned in a first RFID orientation during the first time period;
detecting, at the antenna of the RFID reader, a second signal from the EPC tag during a second time period, wherein the RFID reader is positioned in a second RFID orientation during the second time period;
measuring variance of received signal strength between the first signal and the second signal from the EPC tag;
determining an orientation of the EPC tag relative to the antenna of the RFID reader based in part on one or more of the variance of the received signal strength, the first RFID orientation, or the second RFID orientation; and
identifying a location of the EPC tag based on the orientation of the EPC tag relative to the antenna of the RFID reader.

20. The computer readable medium of claim 19, further comprising code for:
outputting an inventory count associated with the EPC tag in a zone of interest.

21. The computer readable medium of claim 19, wherein identifying the location of the EPC tag based in part on the orientation of the EPC tag relative to the antenna of the RFID reader is performed by generating virtual shielding to separate zones of physical space.
